(19) United States
(12) Patent Application Publication
(10) Pub. No.: US 2026/0008075 A1
(43) Pub. Date: Jan. 8, 2026

(54) SECONDARY BATTERY ELECTRODE PLATE MANUFACTURING APPARATUS INCLUDING DIE PARALLELISM MAINTAINING DEVICE

(71) Applicant: SAMSUNG SDI CO., LTD., Yongin-si (KR)

(72) Inventors: Sungkyun Jung, Yongin-si (KR); Hongwoo Jeon, Yongin-si (KR); Yongseung SHIN, Yongin-si (KR); Hee Taek LIM, Yongin-si (KR)

(21) Appl. No.: 19/169,829

(22) Filed: Apr. 3, 2025

(30) Foreign Application Priority Data
Jul. 5, 2024 (KR) 10-2024-0089203

(51) Int. Cl. B05C 9/12; H01M 4/04

(52) U.S. Cl. CPC B05C 9/12; H01M 4/0404; H01M 4/0435

(57) ABSTRACT

A secondary battery electrode plate manufacturing apparatus includes: a coating unit configured to coat a substrate with an electrode material; a rolling unit configured to roll the coated substrate; and a notching unit configured to notch the rolled substrate to manufacture an electrode plate having a tab. The notching unit includes a die including: an upper die; a lower die; and a parallelism correction block configured to apply pressure to the upper die such that the upper die is lowered while maintaining parallelism with respect to the lower die.

### CROSS-REFERENCE TO RELATED APPLICATION

The present application claims priority to and the benefit of Korean Patent Application No. 10-2024-0089203, filed on Jul. 5, 2024, in the Korean Intellectual Property Office, the entire disclosure of which is incorporated herein by reference.

### BACKGROUND

### 1. Field

Aspects of embodiments of the present disclosure relate to a secondary battery electrode plate manufacturing apparatus including a die parallelism maintaining device.

### 2. Description of Related Art

Different from primary batteries, which are not designed to be recharged, secondary batteries are batteries that are designed to be charged and discharged. Generally, a secondary battery includes an electrode assembly including a positive electrode plate, a negative electrode plate, and a separator.

The positive or negative electrode plate may be manufactured through coating unit, rolling unit, slitting unit, notching unit, and the like. In a notching process, an electrode plate is manufactured by cutting unnecessary portions of a substrate by using the notching unit including a shear die to form electrode tabs. The shear die includes a pair of punches and a pair of dies for forming a bottom and a tab of a substrate and is installed in press equipment to operate the punches and dies.

Parallelism of a shear die ensures precise manufacturing of a design shape. Because an upper die and a lower die are coupled to press equipment, the parallelism of the die (or the die parallelism) may be determined based on the parallelism of the press equipment. However, during use, the parallelism of the press equipment may be inconsistent and may change at random. When the parallelism of a die changes, the verticality of a punch changes, which makes it difficult to maintain a consistent clearance of an electrode plate, generates burrs, and causes damage to the punch and the die, resulting in problems, including reduced product quality and die lifespan.

The above information disclosed in this Background section is for enhancement of understanding of the background of the present disclosure, and therefore, it may contain information that does not constitute a related (or prior) art.

### SUMMARY

Embodiments of the present disclosure are directed to an improved method for maintaining parallelism of a die.

According to an embodiment of the present disclosure, a secondary battery electrode plate manufacturing apparatus includes a coating unit configured to coat a substrate with an electrode material, a rolling unit configured to roll the coated substrate, and a notching unit configured to notch the rolled substrate to manufacture an electrode plate including a tab. The notching unit includes a die including an upper die, a lower die, and a parallelism correction block configured to apply pressure to the upper die such that the upper die is lowered while maintaining parallelism with respect to the lower die.

The die may further include an upper slide fastened to the upper die, a floating bar connecting the upper slide and the upper die, fastened to the upper slide, and inserted into the upper die to be vertically movable and to be laterally fixed (e.g., not laterally movable), and a load support portion protruding from the upper die toward the upper slide and contacting a lower surface of the upper slide to support a load.

According to another embodiment of the present disclosure, a die parallelism maintaining device includes an upper die, a lower die, and a parallelism correction block configured to apply pressure to the upper die such that the upper die is lowered while maintaining parallelism with respect to the lower die.

The die may further include an upper slide fastened to the upper die, a floating bar connecting the upper slide and the upper die, fastened to the upper slide, and inserted into the upper die to be vertically movable and to be laterally fixed, and a load support portion protruding from the upper die toward the upper slide and contacting a lower surface of the upper slide to support a load.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 schematically illustrates an electrode assembly of a secondary battery;

FIG. 2 schematically illustrates a pouch-type secondary battery;

FIG. 3 is a cross-sectional view of a cylindrical secondary battery;

FIG. 4 is cross-sectional view of a prismatic secondary battery;

FIG. 5 illustrates shapes of an electrode plate before and after shearing of an electrode plate by a shear die;

FIG. 6A is a schematic conceptual view of a shear die according to embodiments of the present disclosure;

FIG. 6B is a perspective view of press equipment on which a punch and a die shown in FIG. 6A are installed;

FIG. 7A is a vertical cross-sectional view of the press equipment shown in FIG. 6B;

FIG. 7B is a schematic illustration of deviation of parallelism of press equipment between a punch and a die;

FIG. 8A is a vertical cross-sectional view illustrating a schematic configuration of a die parallelism maintaining device according to embodiments of the present disclosure;

FIG. 8B is a plan view of a punch holder from which an upper slide is removed;

FIG. 9A illustrates a more detailed configuration of that shown in FIG. 8A;

FIG. 9B illustrates a modified embodiment of that shown in FIG. 9A;

FIGS. 10A to 10C are vertical cross-sectional views illustrating a parallelism maintaining action of a die structure described above; and

FIG. 11 is a vertical cross-sectional view of a die according to another embodiment of the present disclosure.

### DETAILED DESCRIPTION

Hereinafter, embodiments of the present disclosure will be described, in detail, with reference to the accompanying drawings. The terms or words used in the present specification and claims should not be narrowly interpreted according to their general or dictionary meanings but should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

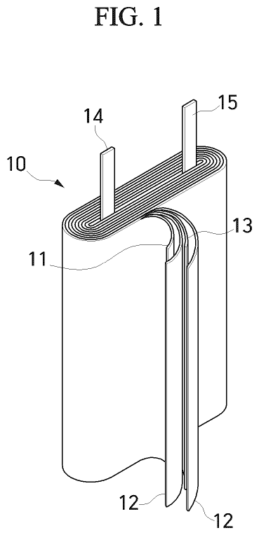

FIG. 1 shows an electrode assembly of a secondary battery.

Referring to FIG. 1, an electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to a longitudinal direction of a case. In other embodiments, the electrode assembly 10 may be a stack type rather than a winding type, but the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case is not limited in the present disclosure. The first electrode plate 11 of the electrode assembly 10 may act as a negative electrode, and the second electrode plate 13 may act as a positive electrode. Of course, the reverse is also possible.

Using the coating unit, the first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The substrate coated with the first electrode active material may be rolled by a rolling unit. The first electrode tab 14 may be connected to an external first terminal. In some embodiments, when the first electrode plate 11 is manufactured, the first electrode tab 14 may be formed by being cut, using the notching unit, in advance to protrude to (or protrude from) one side of the electrode assembly 10, or the first electrode tab 14 may protrude to one side of the electrode assembly 10 more than (e.g., farther than or beyond) the separator 12 without being separately cut.

Using the coating unit, the second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The substrate coated with the second electrode active material may be rolled by a rolling unit. The second electrode tab 15 may be connected to an external second terminal. In some embodiments, the second electrode tab 15 may be formed by being cut, using the notching unit, in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

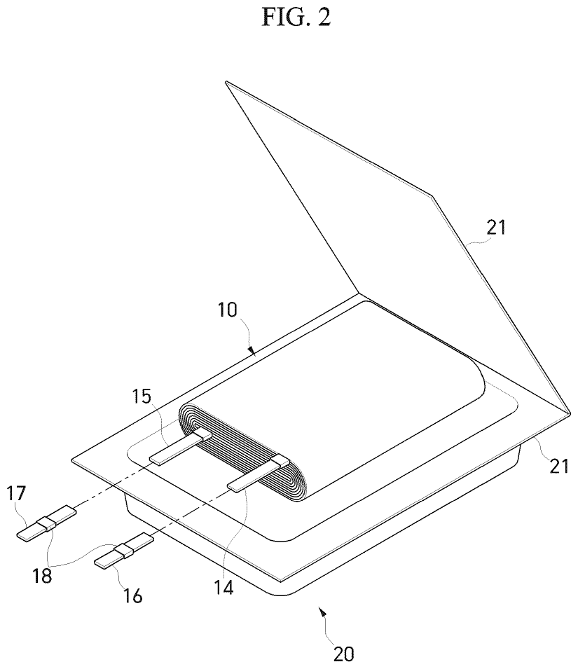

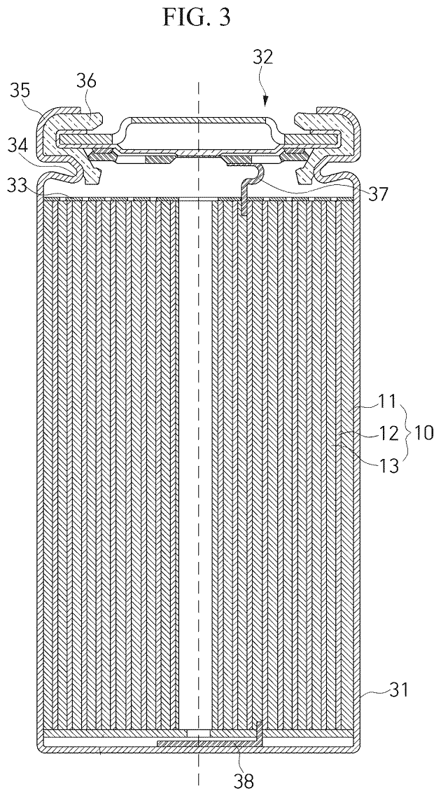

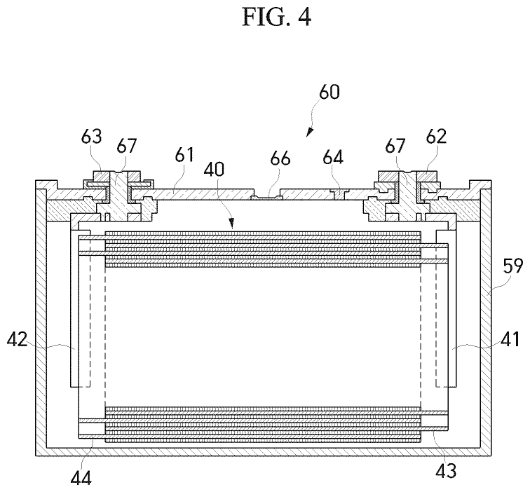

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal case (or casing) (see, e.g., FIGS. 3 and 4).

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

FIG. 2 schematically illustrates a pouch-type secondary battery.

In FIG. 2, the pouch-type secondary battery may include an electrode assembly 10 and a pouch 20 that accommodates the electrode assembly 10.

A first electrode tab 14 and a second electrode tab 15 of the electrode assembly 10 as shown in, for example, FIG. 1 may be welded and electrically connected to an external first terminal lead 16 and an external second terminal lead 17, respectively. Tab films 18 may be attached to the first terminal lead 16 and the second terminal lead 17 for insulation from the pouch 20.

In a state in which the electrode assembly 10 is accommodated in the pouch 20, sealing portions 21 may be in contact with each other to seal the pouch 20, and the sealing may be achieved in a state in which the tab films 18 are interposed between the sealing portions 21. The sealing portion 21 of the pouch 20 may be made of a heat fusion material. Because the heat fusion material generally exhibits weak adhesion to metals, the sealing portion 21 may be fused to the pouch 20 by interposing the tab films 18 in the form of a thin film.

FIG. 3 is a cross-sectional view of a cylindrical secondary battery. The cylindrical secondary battery includes an electrode assembly 10, a case 31 that accommodates the electrode assembly 10 and an electrolyte therein, a cap assembly 32 that is coupled to an opening of the case 31 to seal the case 31, and an insulating plate 33 that is positioned between the electrode assembly 10 and the cap assembly 32 inside the case 31.

The case 31 accommodates the electrode assembly 10 and the electrolyte and forms an exterior of a battery together with the cap assembly 32. The case 31 may include a body having an approximately cylindrical shape and a bottom. A beading portion 34 that is deformed inwardly may be formed in the body of the case 31, and a crimping portion 35 that is bent inwardly may be formed at an end portion of an open end of the body of the case 31.

The beading portion 34 may suppress the electrode assembly 10 from moving inside the case 31 and may facilitate the seating of a gasket 36 and the cap assembly 32. The crimping portion 35 may firmly fix the cap assembly 32 by pressing an edge of the cap assembly 32 through the gasket 36. The case 31 may be made of, for example, nickel-plated iron.

The cap assembly 32 may be fixed inside the crimping portion 35 through the gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 illustrates an interior and cap assembly 60 of a prismatic secondary battery.

An electrode assembly 40 used in the prismatic secondary battery may be formed by winding or stacking a first electrode plate, a separator, and a second electrode plate, which are formed in a plate shape or film shape, as shown in, for example, FIG. 1. When the electrode assembly 40 is a wound stack, a winding axis may be parallel to a longitudinal direction of a case. In addition, the electrode assembly 40 may be a stack type other than a wound type, but a shape of the electrode assembly 40 is not limited in the present disclosure. In addition, the electrode assembly 40 may be a Z-stack electrode assembly in which the first electrode plate and the second electrode plate are inserted into both sides of the separator, which is bent (or folded) into a Z-stack. In addition, one or more electrode assemblies 40 may be stacked such that long side surfaces thereof are adjacent to each other and may be accommodated inside the case, and the number of electrode assemblies is not limited in the present disclosure. The first electrode plate of the electrode assembly 40 may act as a negative electrode, and the second electrode plate may act as a negative electrode, or vice versa.

A first electrode tab 43 of the first electrode plate and a second electrode tab 44 of the second electrode plate are each positioned on the electrode assembly 40. In some embodiments, the electrode assembly 40 may be accommodated in a case 59 together with an electrolyte.

The first electrode tab 43 and the second electrode tab 44 may be connected to a first current collector 41 and a second current collector 42 through welding, respectively. The first current collector 41 and the second current collector 42 are respectively connected to a first terminal 62 and the second terminal 63 through connection members 67. In some embodiments, outer peripheral surfaces of the connection member 67 may be threaded and may be connected to the first terminal 62 and the second terminal 63 through screw coupling. However, the present disclosure is not limited thereto, and the connection members 67 may be connected to the first terminal 62 and the second terminal 63 through riveting or welding.

A process of manufacturing an electrode plate (e.g., a first electrode plate 11 or a second electrode plate 13) of the electrode assembly (see, e.g., FIG. 1) will be briefly described.

A substrate for manufacturing the electrode plate may be a metal foil including aluminum (Al) (in the case of a positive electrode) or a metal foil including copper (Cu) or nickel (Ni) (in the case of a negative electrode). In a coating process, a slurry or powder-state mixture (e.g., an electrode material) prepared in advance is applied on the substrate to form a coating layer, using the coating unit including a slot die. The mixture applied here is as described above. Next, in a roll pressing process, the coated substrate may be rolled by the rolling unit including rollers to manufacture a high-capacity and high-density secondary battery. The rolled substrate is cut, using the slitting unit, in a length direction in a slitting process to separate individual electrode plates, which are subsequently shaped into individual electrode plates, using the notching unit, in a notching process.

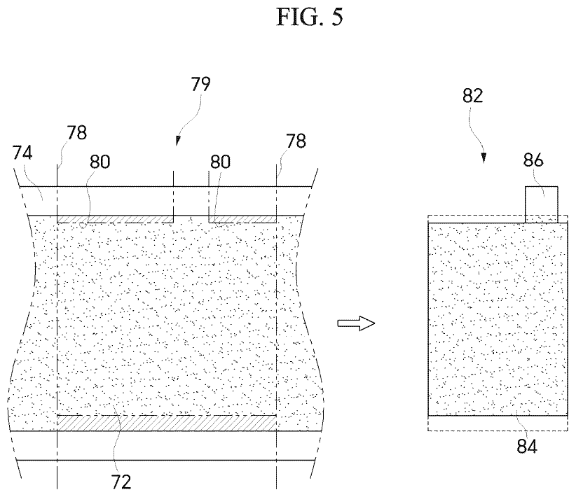

FIG. 5 is a schematic view describing a notching process and illustrating a shape of an electrode plate before and after notching.

In the notching process, a substrate 79 coated with an active material 72 in advance may be cut laterally along a lateral cutting line 78 and longitudinally along a longitudinal cutting line 80 by a notching unit. In addition, the notching unit may delete (e.g., remove) and clean up uncoated portions 74 and 76 along shaping lines 81. Finally, as shown on the right side of FIG. 5, a notched electrode plate has an area 84 coated with a positive or negative electrode material and a tab 86, which is an uncoated area. The tab 86 is a portion to which a conductive member, such as a current collector or subplate, is to be bonded in a subsequent electrode assembly process.

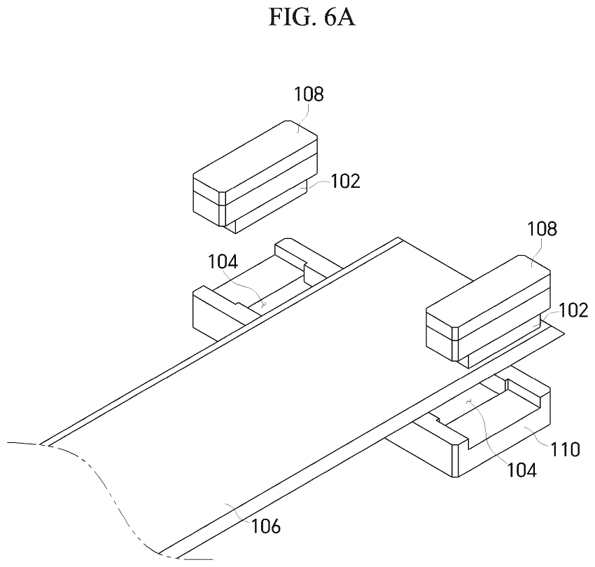

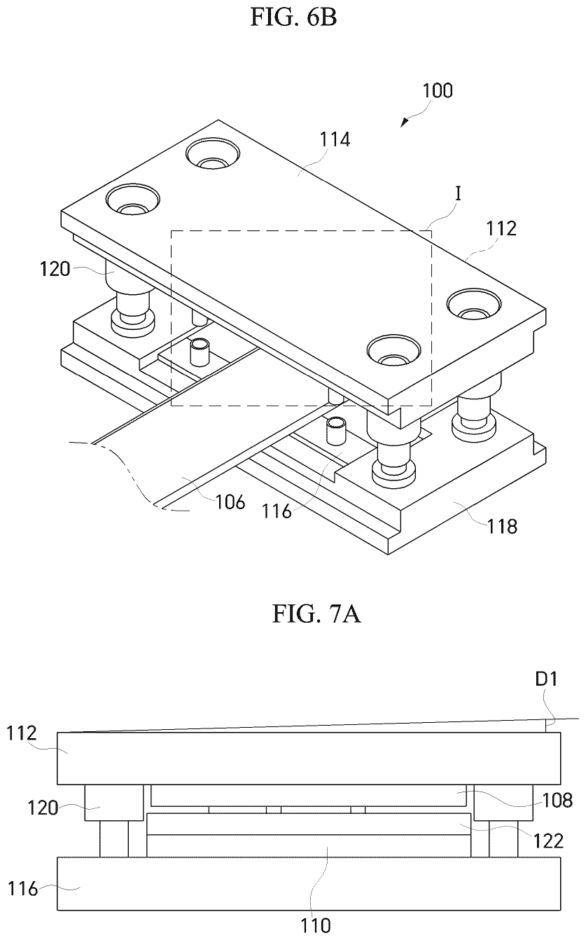

FIG. 6A is a schematic conceptual view of a notching die included in the notching unit, according to embodiments of the present disclosure.

When an electrode plate 106 is loaded on a die 104, a punch 102 is lowered to punch the electrode plate 106 in a shape that has been designed to manufacture an electrode plate having a shape as shown in, for example, FIG. 5. The punch 102 may be supported on a punch plate 108, and the die 104 may be supported on a die plate 110.

The punch 102 and the die 104 may include a pair of punches and a pair of dies to concurrently (or simultaneously) punch and shape the tab 86 of the electrode plate shown in, for example, FIG. 5 and a side opposite thereto.

FIG. 6B is a perspective view of press equipment for operating the punch 102 and the die 104 shown in FIG. 6A. The mechanism shown in FIG. 6A is included in area I of FIG. 6B.

A notching die 100 may include an upper die and a lower die.

The upper die may include a punch holder 112 to which the punch plate 108 is fixed and an upper slide 114 that supports the punch holder 112. The lower die may include a die holder 116 to which the die plate 110 is fixed and a lower slide 118 that supports the die holder 116. The upper die may move vertically relative to the lower die via a guide post 120.

The upper slide 114 and the punch holder 112 may be coupled in a clamp or shank fastening manner.

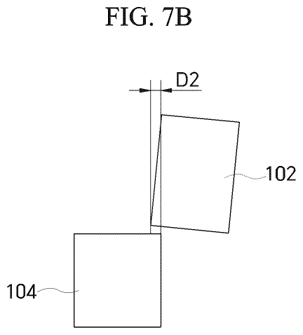

FIG. 7A is a vertical cross-sectional view of the press equipment for notching shown in FIG. 6B in which the upper and lower slides 114 and 118 are removed and illustrates a deviation of parallelism. Here, the reference numeral 122 denotes a stripper that separates the punched electrode plate.

Because parallelism of the press equipment is not always consistent, parallelism of a die depends on the parallelism of the press equipment, which makes it difficult to maintain consistent parallelism. When a deviation in parallelism occurs, the punch 102 cannot be vertically inserted (or cannot be smoothly inserted) into the die 104, which may cause problems in shear quality and damage to the punch and the die.

Because the upper die and the lower die should simultaneously operate due to the characteristics of the press equipment, the press equipment is manufactured to be lightweight. As a result, it may be difficult to manufacture and modify the press equipment to firmly and accurately maintain consistent parallelism. In addition, because parallelism may change randomly during equipment operation, it is not easy to adjust the parallelism by using a fixed correction method.

FIG. 7B illustrates the effect of a deviation of parallelism of the press equipment on the punch 102 and the die 104. The verticality of the punch 102 may change according to die parallelism. As shown in FIG. 7A, when parallelism of the upper die exhibits a parallelism deviation of D1, a verticality deviation of the punch 102 may be D2. For example, when D1=40 μm, D2=4.7 μm, which not only affects a shape, area, etc. of an electrode plate but also causes quality problems, such as burrs remaining on a shear plane of the electrode plate and serious problems including damage to the punch 102 and die 104 and damage to surrounding members.

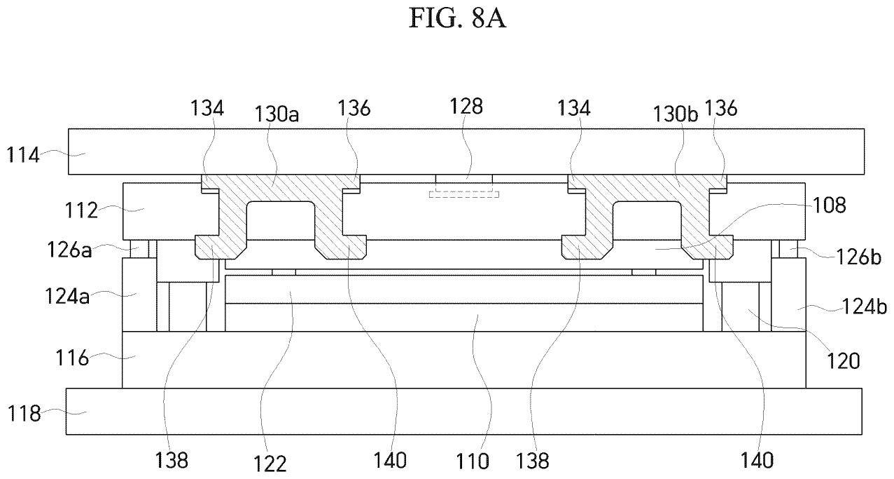

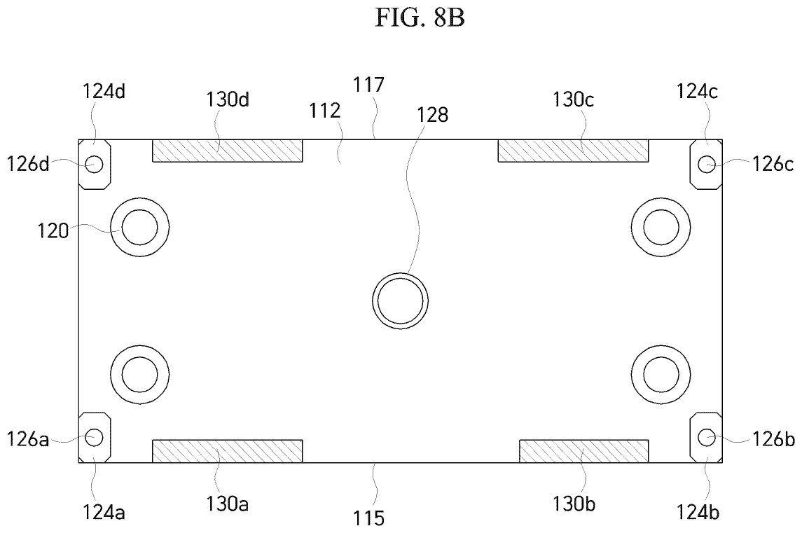

FIG. 8A is a vertical cross-sectional view illustrating a schematic configuration of a die parallelism maintaining device according to embodiments of the present disclosure. FIG. 8B is a plan view of a punch holder 112 from which an upper slide 114 is removed. A configuration and an action will the die parallelism maintaining device according to embodiments of the present disclosure be briefly described first.

Parallelism correction blocks 126a, 126b, 126c, and 126d are installed at four corners of a lower die holder 116 and come into contact with an upper punch holder 112.

The parallelism correction blocks 126a, 126b, 126c, and 126d may be inserted into supports 124a, 124b, 124c, and 124d and may be elastically (or reciprocally) moved vertically.

Four floating bars 130a, 130b, 130c, and 130d may be vertically inserted into an outer portion of the upper punch holder 112. The floating bars 130a, 130b, 130c, and 130d may have a bar shape when viewed from above.

Two floating bars 130a and 130b may be inserted at positions close to the parallelism correction blocks 126a and 126b disposed at both end portions of a first long side 115 of the punch holder 112, and the other two floating bars 130c and 130d may be inserted at positions close to the parallelism correction blocks 126c and 126d disposed at both end portions of a second long side 117 of the punch holder 112.

The floating bars 130a, 130b, 130c, and 130d may each be fastened to the upper slide 114. The fastening may be performed through bolt fastening, a quick die change (QDC) clamp, etc.

The floating bars 130a, 130b, 130c, and 130d fastened to the upper slide 114 may be inserted to the punch holder 112 to be vertically movable and but not be laterally movable. To this end, each of the floating bars 130a, 130b, 130c, and 130d may include a component for regulating movement so that each of the floating bars 130a, 130b, 130c, and 130d vertically only moves a certain (or maximum) distance. For example, as shown, in each of the floating bars 130a, 130b, 130c, and 130d, first and second end upper portions 134 and 136 further extend in a length direction of the bar, and first and second lower end portions 138 and 140 further extend in the length direction of the bar.

A load support portion 128 may protrude upwardly (e.g., toward the upper slide 114) from a central portion of the punch holder 112, that is, from approximately a central portion of an area occupied by the four floating bars 130a, 130b, 130c, and 130d. The load support portion 128 comes into contact with a lower surface of the upper slide 114 and supports a load thereof.

Through such a configuration, the parallelism correction blocks 126a, 126b, 126c, and 126d, the floating bars 130a, 130b, 130c, and 130d, and the load support portion 128 may be installed in a die. An upper die may move vertically independent of the upper slide 114 via the floating bars 130a, 130b, 130c, and 130d, and parallelism of the upper die and a lower die may be maintained by the parallelism correction blocks 126a, 126b, 126c, and 126d.

Therefore, the die may maintain parallelism on its own without being affected by parallelism of press equipment mounted on the upper slide 114. Accordingly, the punch holder 112 may be vertically lowered and maintained so that a punch 102 may be inserted into a die 104 without deviation, thereby preserving the durability of the die and the press equipment and maintaining the quality of a shear plane of an electrode. A frequency of maintenance of a die/press can be reduced, and a lifespan of the die/press can be increased, thereby increasing production and reducing investment cost.

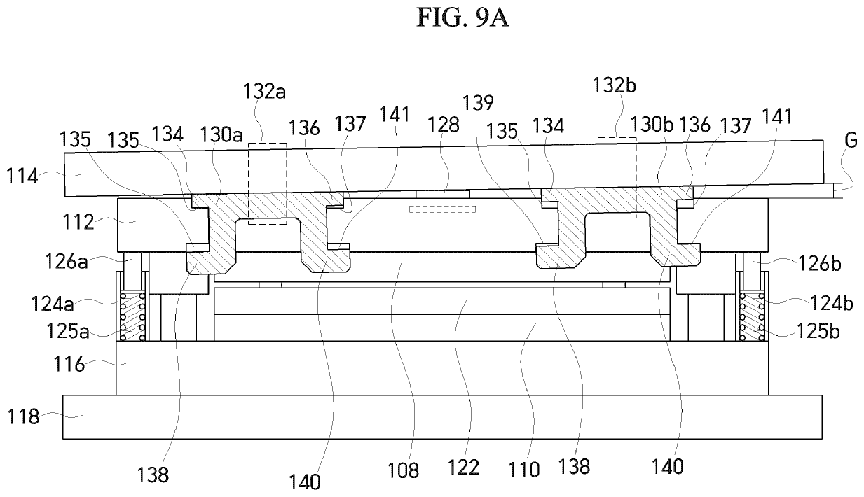

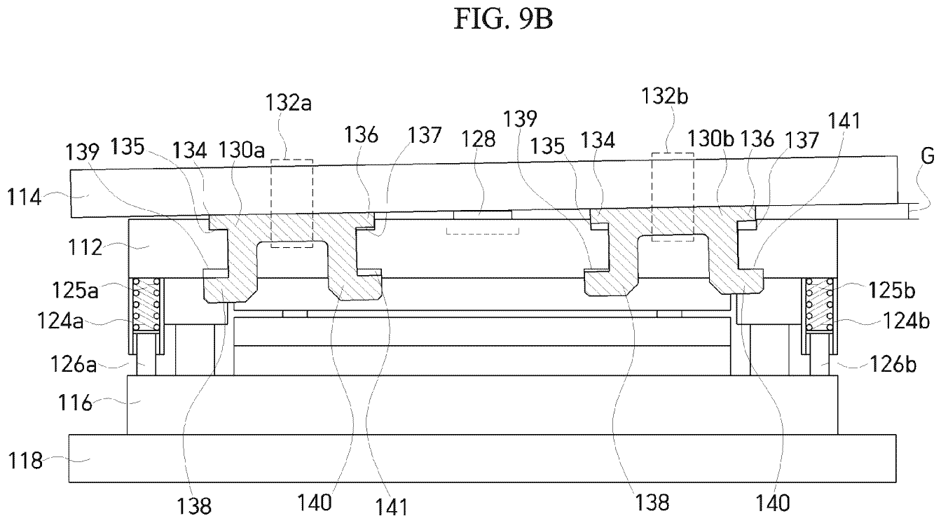

FIG. 9A illustrates a more detailed configuration of that shown in FIG. 8A. FIG. 9B illustrates a modified embodiment of that shown in FIG. 9A.

From among the four floating bars 130a, 130b, 130c, and 130d shown in FIG. 8B, two floating bars 130a and 130b at the front are shown.

The floating bars 130a and 130b may be fastened to the upper slide 114 by using fastening components 132a and 132b, such as bolts, QDC devices, etc.

The upper slide 114 is shown as being tilted counterclockwise such that a gap G is formed at a right side of the upper slide 114. However, the punch holder 112 positioned below the upper slide 114 remains horizontal because the punch holder 112 is placed horizontally due to the parallelism correction blocks 126a, 126b, 126c, and 126d installed on the die holder 116 therebelow.

To allow the punch holder 112 to remain horizontal even when the upper slide 114 is tilted, the floating bars 130a, 130b, 130c, and 130d may be inserted into the punch holder 112 to be vertically movable.

For such vertical movement, a first upper recessed portion 135 that may accommodate a lower surface of the first upper end portion 134 of each of the floating bars 130a, 130b, 130c, and 130d and a second upper recessed portion 137 that may accommodate a lower surface of the second upper end portion 136 of each of the floating bars 130a, 130b, 130c, and 130d may be formed in an upper surface of the punch holder 112. In addition, a first lower recessed portion 139 that may accommodate an upper surface of the first lower end portion 138 of each of the floating bars 130a, 130b, 130c, and 130d and a second lower recessed portion 141 that may accommodate an upper surface of the second lower end portion 140 of each of the floating bars 130a, 130b, 130c, and 130d may be formed in a lower surface of the punch holder 112.

Thus, as long as the floating bars 130a, 130b, 130c, and 130d have a structure that may be approximately fixed to the die (e.g., to the punch holder 112) but may be moved vertically and fastened to the upper slide 114 of the press equipment through clamps or the like to enable the upper die to move when the equipment operates, the floating bars 130a, 130b, 130c, and 130d may be manufactured in other suitable shapes (for example, a [symbol] shape) other than a shape of [symbol] as shown in the drawing.

The parallelism correction blocks 126a, 126b, 126c, and 126d may be elastically moved vertically by elastic bodies 125a, 125b, 125c, and 125d inserted into the supports 124a, 124b, 124c, and 124d as described above. The parallelism correction blocks 126a, 126b, 126c, and 126d are installed at four corners of the die (e.g., of the die holder 116) to apply a force to the punch holder 112 of the upper die with the same pressure after punching by the punch 102 before a stripper plate 122 operates, thereby allowing the upper die to remain horizontal. As shown in FIG. 9B, the parallelism correction blocks 126a, 126b, 126c, and 126d are installed on the lower surface of the punch holder 112 of the upper die. In such an embodiment, contrary to that described above, the parallelism correction blocks 126a, 126b, 126c, and 126d apply pressure to the lower die, that is, to the die holder 116.

The load support portion 128 protrudes above the punch holder 112 and supports the upper slide 114 to form a gap between the press equipment and the die and allows the upper die to move with respect to a contact surface in contact with the lower surface of the upper slide 114 of the press equipment.

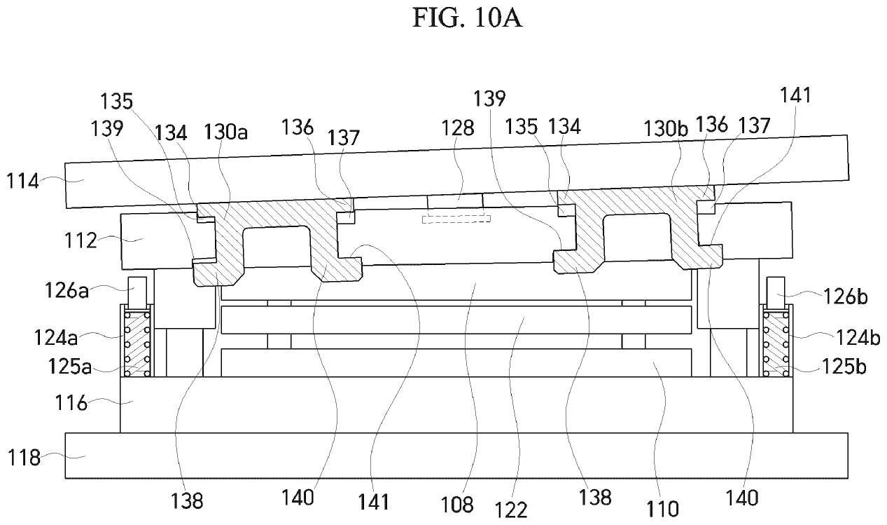

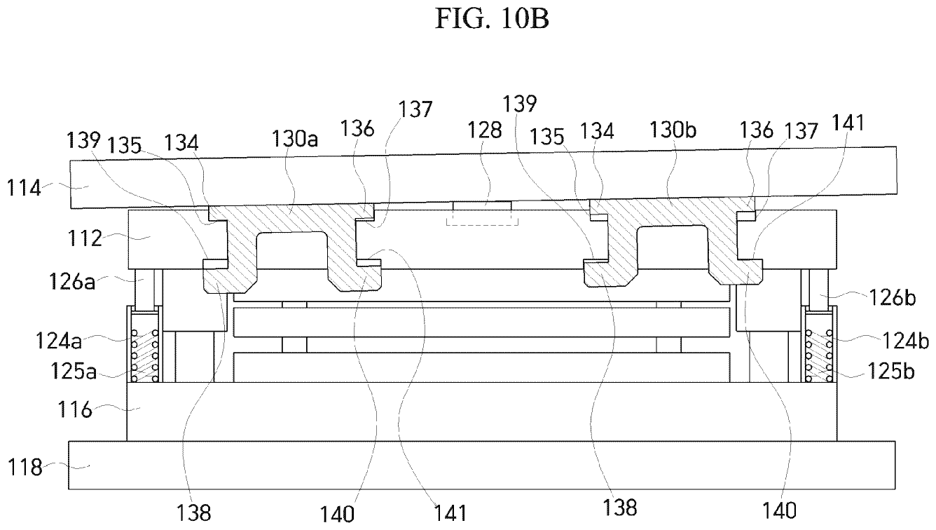

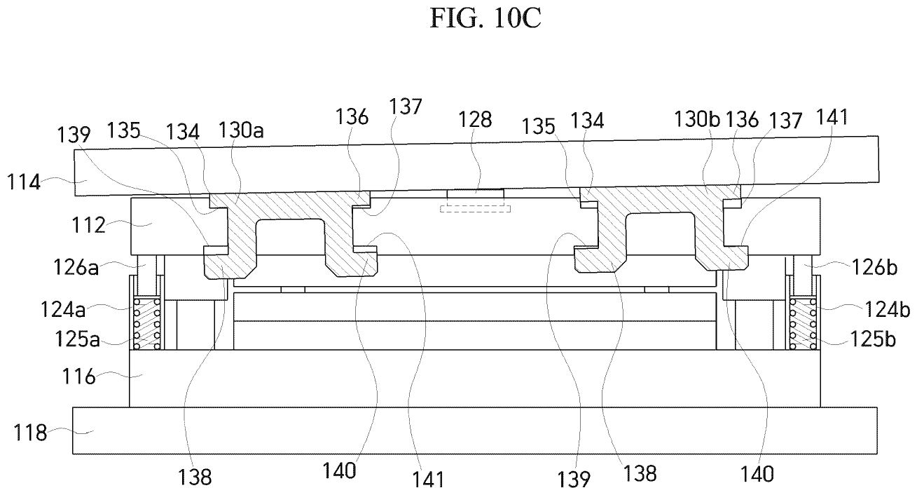

FIGS. 10A to 10C are vertical cross-sectional views describing a parallelism maintaining action of a die structure described above.

FIG. 10A shows a state in which the upper slide 114 and the punch holder 112, the punch plate 108, and a stripper 122, which are positioned therebelow, are tilted at a top dead center of the die. Because die tolerances, such as a perpendicularity tolerance of a guide post and a tolerance of a ball retainer, are present at the top dead center, a change in parallelism of the press equipment is followed by parallelism of the die, and thus, the die is tilted to a similar incline. In FIG. 10A, because the upper slide 114 of the press equipment is tilted, and the floating bars 130a, 130b, 130c, and 130d connected thereto are also tilted, the punch holder 112 into which the floating bars 130a, 130b, 130c, and 130d are inserted are also tilted to a similar degree when the upper slide 114 is tilted.

FIG. 10B illustrates a state in which the upper die is lowered from a top dead center position for punching. When the parallelism correction blocks 126a, 126b, 126c, and 126d come into contact with the lower surface of the punch holder 112 as the upper die is lowered, the upper die receives the same pressure as the lower die (including the die holder 116) at four positions with respect to the guide posts and maintains a horizontal state. Even in this case, the tilting of the upper slide 114 remains unchanged.

FIG. 10C illustrates a bottom dead center to which the upper die is further lowered. As the punch holder 112 is further lowered, the parallelism correction blocks 126a, 126b, 126c, and 126d are further inserted into the supports 124a, 124b, 124c, and 124d, and the punch holder 112 and the stripper 122 come into contact with the die plate 110. It can be seen that the upper die, that is, the punch holder 112, and the punch holder 112 and the stripper 122 therebelow are maintained to be parallel to the lower die, that is, the die plate 110 and the die holder 116, and the tilting of the upper slide 114 remains unchanged.

In this way, according to embodiments of the present disclosure, a gap may be formed between the equipment and the die by using the floating bars 130a, 130b, 130c, and 130d and the load support portion 128, the punch holder 112 of the upper die may be moved independently of the upper slide 114 of the equipment, and before the punch is inserted into the die, the parallelism correction blocks 126a, 126b, 126c, and 126d assist the upper die in remaining horizontal to be lowered, thereby consistently maintaining parallelism of the die separately from a parallelism of the equipment. In summary, a space in which an upper die of a die may move is formed between a lower surface of a press slide and an upper holder (e.g., the punch holder 112) of the die by using a floating bar and a load support portion, thereby allowing the upper die of the die to move. In addition, pressure may be applied to the upper die with the parallelism correction blocks 126a, 126b, 126c, and 126d to uniformly lower the upper die so that the die (e.g., the punch holder 112 and die holder 116) may maintain consistent parallelism without being affected by parallelism of the press equipment (e.g., the upper slide 114).

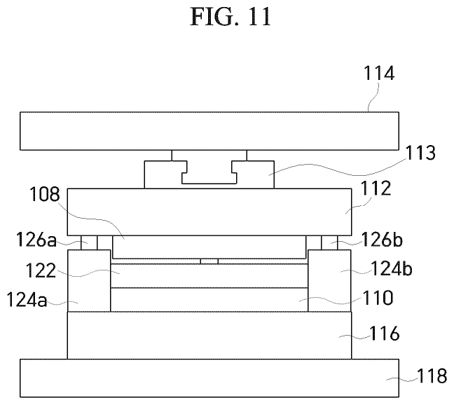

FIG. 11 is a vertical cross-sectional view of a die according to other embodiments of the present disclosure.

The dies shown in FIGS. 8A to 10C are related to a structure in which an upper slide 114 and a punch holder 112 of an equipment are connected by a clamp, but aspects and features of the present disclosure may also be applied to a structure in which the upper slide 114 and the punch holder 112 are connected by a shank.

In a shank fastening manner, the upper slide 114 and the punch holder 112 are fastened only at central portions to transmit a force, an upper surface of the die (e.g., the punch holder 112) cannot be pressed with the exception of a shank fastening portion 113, and thus, the parallelism of the die is expected to change significantly.

In an embodiment that utilizes the shank fastening configuration, the floating bars 130a, 130b, 130c, and 130d and load support portion 128 described above cannot be applied structurally, and parallelism may be maintained by using parallelism correction blocks 126a, 126b, 126c, and 126d. For example, when an upper die is lowered, the parallelism correction blocks 126a, 126b, 126c, and 126d installed at four corners of a lower die apply uniform pressure to the upper die, thereby allowing the upper die to be lowered while maintaining consistent parallelism with respect to the lower die.

In other embodiments, the parallelism correction blocks 126a, 126b, 126c, and 126d are installed at four corners of the upper die so that the upper die may be lowered while applying uniform pressure to the lower die.

An apparatus according to embodiments of the present disclosure may consistently maintain parallelism of a die independent of equipment even when parallelism of an electrode shear die changes during the operation of press equipment. By preventing vertical insertion malfunction of a punch caused by a deviation of parallelism of a die, the occurrence of burrs and damage to the punch and a die can be reduced or minimized.

According to embodiments of the present disclosure, a space in which an upper die may move is formed between a lower surface of a press slide and an upper holder by using a floating bar and a load support portion, thereby allowing the upper die to move. In addition, by applying pressure to an upper die with a parallelism correction block to uniformly lower the upper die, a punch holder and a die holder can maintain consistent parallelism without being affected by parallelism of the press equipment (e.g., an upper slide).

Aspects and features of the present disclosure can be applied not only to a shear die for a secondary battery electrode plate but also to dies for other purposes that require maintenance of parallelism.

Although the present disclosure has been described above with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery electrode plate manufacturing apparatus comprising:
a coating unit configured to coat a substrate with an electrode material;
a rolling unit configured to roll the coated substrate; and
a notching unit configured to notch the rolled substrate to manufacture an electrode plate having a tab, the notching unit comprising a die comprising:
an upper die;
a lower die; and
a parallelism correction block configured to apply pressure to the upper die such that the upper die is lowered while maintaining parallelism with respect to the lower die.

2. The secondary battery electrode plate manufacturing apparatus as claimed in claim 1, wherein the parallelism correction block is installed on one of the upper die and the lower die to face the other one of the upper die and the lower die.

3. The secondary battery electrode plate manufacturing apparatus as claimed in claim 2, wherein the parallelism correction block comprises four parallelism correction blocks, and
wherein the four parallelism correction blocks are respectively installed at four corners of one of the upper die and the lower die.

4. The secondary battery electrode plate manufacturing apparatus as claimed in claim 1, wherein the die further comprises:
an upper slide fastened to the upper die;
a floating bar connecting the upper slide and the upper die, fastened to the upper slide, and inserted into the upper die to be vertically movable and to be laterally fixed; and
a load support portion protruding from the upper die toward the upper slide and contacting a lower surface of the upper slide to support a load.

5. The secondary battery electrode plate manufacturing apparatus as claimed in claim 4, wherein the floating bar comprises four floating bars vertically inserted into an upper surface of the upper die, and
wherein the load support portion is positioned at a central portion between the four floating bars.

6. The secondary battery electrode plate manufacturing apparatus as claimed in claim 4, wherein the floating bar is fastened to the upper slide through a clamp.

7. The secondary battery electrode plate manufacturing apparatus as claimed in claim 4, wherein the floating bar is inserted into the upper die to regulate a distance that the floating bar moves vertically.

8. The secondary battery electrode plate manufacturing apparatus as claimed in claim 4, wherein the upper die has a recessed portion configured to accommodate a portion of the floating bar.

9. The secondary battery electrode plate manufacturing apparatus as claimed in claim 4, wherein the upper die moves vertically independent of the upper slide.

10. The secondary battery electrode plate manufacturing apparatus as claimed in claim 1, wherein the parallelism correction block elastically moves vertically.

11. A die parallelism maintaining device comprising:
an upper die;
a lower die; and
a parallelism correction block configured to apply pressure to the upper die such that the upper die is lowered while maintaining parallelism with respect to the lower die.

12. The die parallelism maintaining device as claimed in claim 11, wherein the parallelism correction block is installed on one of the upper die and the lower die to face the other one of the upper die and the lower die.

13. The die parallelism maintaining device as claimed in claim 12, wherein the parallelism correction block comprises four parallelism correction blocks, and
wherein the four parallelism correction blocks are respectively installed at four corners of one of the upper die and the lower die.

14. The die parallelism maintaining device as claimed in claim 11, wherein a die further comprises:
an upper slide fastened to the upper die;
a floating bar connecting the upper slide and the upper die, fastened to the upper slide, and inserted into the upper die to be vertically movable and to be laterally fixed; and
a load support portion protruding from the upper die toward the upper slide and contacting a lower surface of the upper slide to support a load.

15. The die parallelism maintaining device as claimed in claim 14, wherein the floating bar comprises four floating bars vertically inserted into an upper surface of the upper die, and
wherein the load support portion is positioned at a central portion between the four floating bars.

16. The die parallelism maintaining device as claimed in claim 14, wherein the floating bar is fastened to the upper slide through a clamp.

17. The die parallelism maintaining device as claimed in claim 14, wherein the floating bar is inserted into the upper die to regulate a distance that the floating bar moves vertically.

18. The die parallelism maintaining device as claimed in claim 14, wherein the upper die has a recessed portion configured to accommodate a portion of the floating bar.

19. The die parallelism maintaining device as claimed in claim 14, wherein the upper die moves vertically independent of the upper slide.

20. The die parallelism maintaining device as claimed in claim 12, wherein the parallelism correction block elastically moves vertically.
